(19) United States
(12) Patent Application Publication
(10) Pub. No.: US 2003/0039714 A1
(43) Pub. Date: Feb. 27, 2003

(54) Food extrusion device

(76) Inventor: Chin-Ta Chiang, Taichung Hsien (TW)

Correspondence Address: BACON & THOMAS, PLLC, 625 SLATERS LANE, FOURTH FLOOR, ALEXANDRIA, VA, 22314

(21) Appl. No.: 09/934,833

(22) Filed: Aug. 23, 2001

(51) Int. Cl. A21C 3/02

(52) U.S. Cl. 425/363; 425/403.1

(57) ABSTRACT

A food extrusion device includes an extruding unit, a rotary unit, a material inlet, and a transfer belt.

The rotary wheels at two sides of the extruding unit are arranged inwards or outwards (or outward or inwards) eccentrically and longitudinally. As the rotary wheels at two sides of the extruding unit rotate inwards or outwards (or outwards or inwards) sequentially with a downward sequence so that the dough slides downwards, the dough presents alternative actions of expansion and contraction (or contraction and expansion) with the outwards and inward rotation of the rotary wheels. Therefore, the force applying area of the dough and the stress applied to the dough by the rotary wheels are reduced. As a consequent, elastic dough is made.

The present invention is a continue-in-part of Taiwan Patent No. 90200934. The specification of the application is incorporated into the present invention as a part of the present specification.

### FIELD OF THE INVENTION

The present invention relates to a food extrusion device, and particularly to a food extrusion device in that the force applying area of dough and the stress applied to the dough by a rotary wheels 11 are reduced. As a consequent, elastic dough can be made.

### BACKGROUND OF THE INVENTION

A plane view of a prior art food machining device is illustrated, in that, a dough is extruded by rotary wheels at two sides of an extruding space of the device and then the dough is completely adhered to the surface of the rotary wheels. Therefore, the dough is pressured integrally and continuously. In other words, the dough suffers from a larger pressure so that it become hard and is lack of elasticity. As a result, the eater will have a bad feeling to the dough.

Therefore, in the Taiwan Patent No. 90200934, assigned to the applicant of the present invention, a food extrusion device is disclosed, as illustrated in FIG. 2. In that, the dough slides alone a downward natural order. A plurality of teeth spaced with an equal distance is installed at a periphery of the rotary wheels so that pressures are applied to the dough only at the tips of the teeth portion. The force applying area of the dough is reduced to a minimum so that the dough is more elastic and delicious.

However, theses prior art designs are not at an optimum condition, and therefore, some novel improvement is necessary for providing more elastic and delicious dough.

### SUMMARY OF THE INVENTION

Accordingly, the object of the present invention is to provide a food extrusion device, in that rotary wheels at two sides of the extruding unit are arranged outwards and inwards eccentrically and longitudinally. Therefore, the rotary wheels at two side of the extruding unit rotate outwards and inwards sequentially with a downward sequence.

To achieve the object, the present invention provides a food extrusion device includes an extruding unit, a rotary unit, a material inlet, and a transfer belt. The rotary wheels at two sides of the extruding unit are arranged inwards and outwards (or outward and inwards) eccentrically and longitudinally. As the rotary wheels at two side of the extruding unit rotate inwards and outwards (or outwards and inwards) sequentially with a downward sequence so that the dough slides downwards, the dough presents alternative actions of expansion and contraction (or contraction and expansion) with the outwards and inward rotation of the rotary wheels. Therefore, the force applying area of the dough and the stress applied to the dough T by the rotary wheels are reduced. As a consequent, elastic dough T can be made.

The various objects and advantages of the present invention will be more readily understood from the following detailed description when read in conjunction with the appended drawing.

### BRIEF DESCRIPTION OF THE DRAWINGS

FIG. 1 is a plane schematic view of a prior food machine.

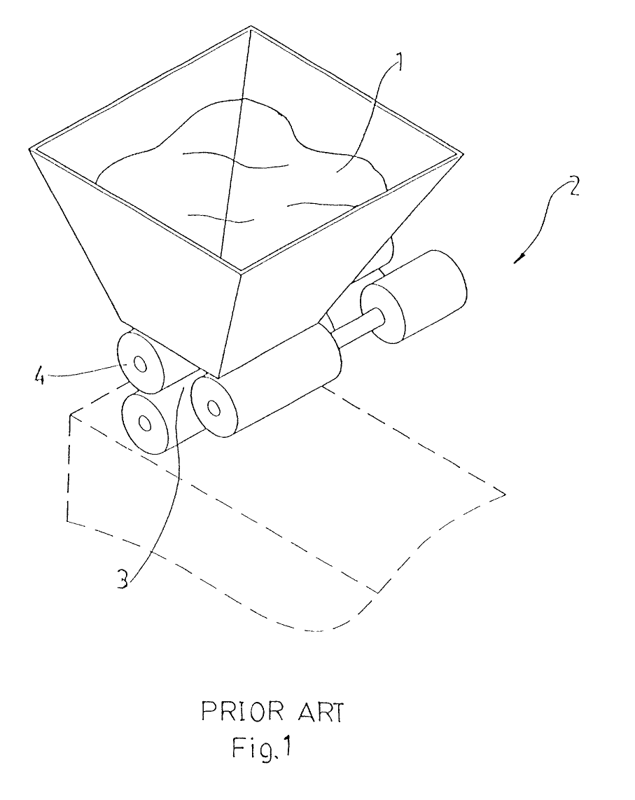

FIG. 2 is a schematic view of the Taiwan Patent No. 90200934.

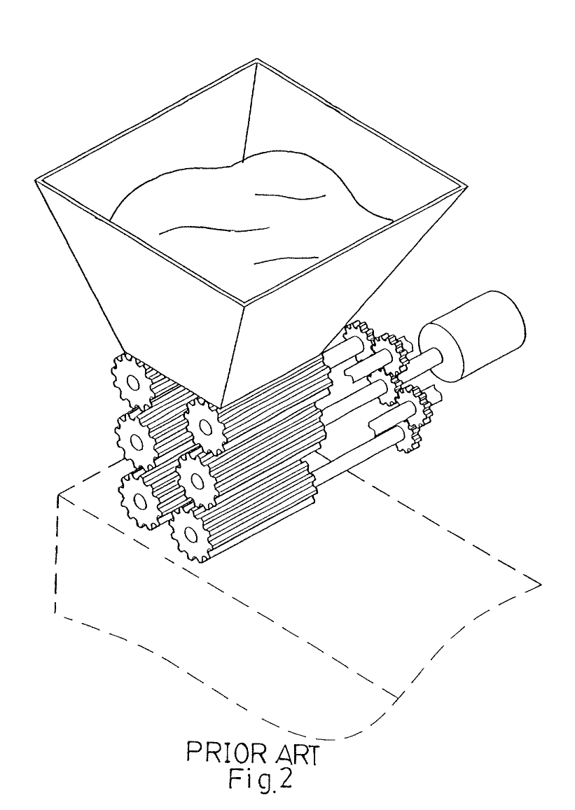

FIG. 3 is a schematic view of the present invention.

FIG. 4 is a plane schematic view of the Taiwan Patent No. 90200934.

FIG. 5A is a plane schematic view showing the operation of the present invention.

FIG. 5B is another plane schematic view showing the operation of the present invention.

FIG. 6 shows another embodiment of the present invention.

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

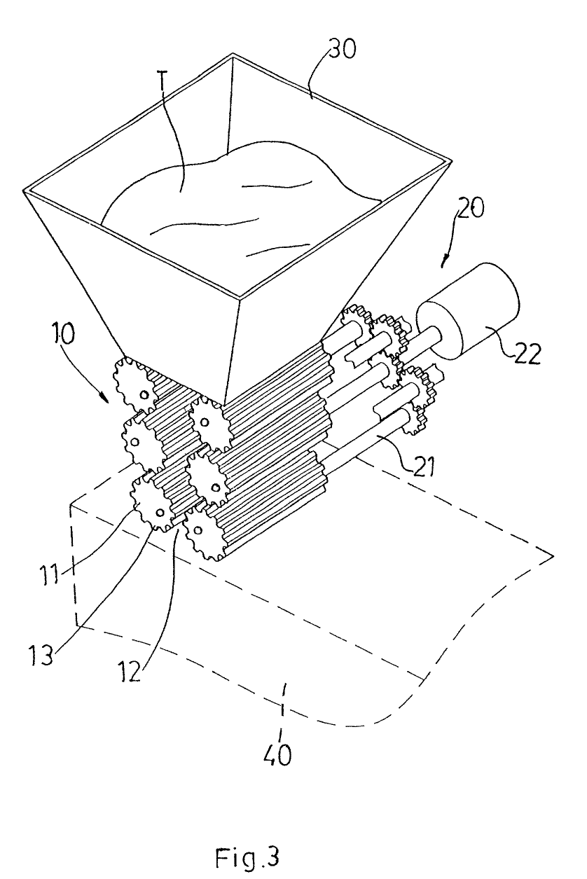

Referring to FIG. 3, the perspective view of the present invention is illustrated. The present invention is related to a food extrusion device. The food extrusion device mainly includes an extruding unit 10, a rotary unit 20, a material inlet 30 and a transfer belt 40.

The extruding unit 10 is formed by a plurality of rotary wheels 11 arranged at two sides longitudinally, and an extruding space 12 is formed between the rotary wheels 11 of two sides.

The rotary unit 20 is formed by a plurality of middle shafts 21 passing through each rotary wheel 11. By actuating a motor 22 to rotate the rotary wheels 11, the rotary wheels 11 at left and right sides rotate clockwise or counterclockwise. Thereby, by rotating the rotary wheels 11 at two sides in different ways, the dough T may successfully flow through the extruding space 12 to the transfer belt 40 at the lower sides for machining.

A material inlet 30 is disposed on the extruding unit 10.

A transfer belt 40 is positioned at a bottom of the extruding space 12 of the extruding unit 10.

By above components, the present invention is formed. In use, the dough T flows to the extruding space 12 through the material inlet 30. Then, by the rotary wheels 11 on the extruding unit 10, the dough T is machined.

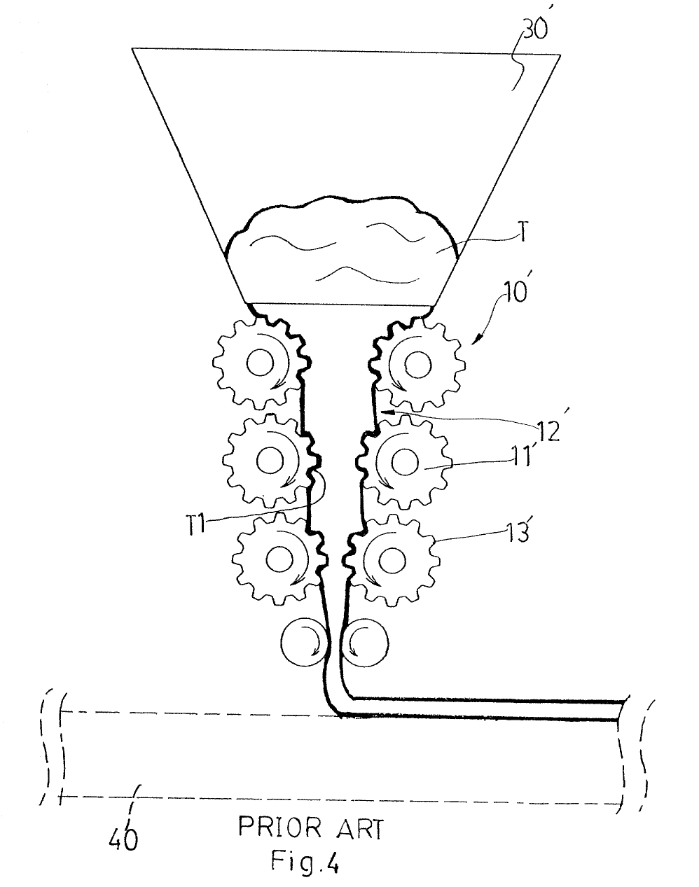

Moreover, referring to FIG. 4, a plane view is illustrated.

Referring to FIG. 4, the extruding unit 10′ has a plurality of rotary wheels 11′. A periphery of the rotary wheels 11 are installed with teeth 13′ spaced with an equal space. Furthermore, by the teeth 13′ on the rotary wheel 11, when the dough T enters into the extruding space 12 from the material inlet 30′, the edge of the dough T is formed with a plurality of recess T1 arranged with respect to the teeth 13′. In other words, the dough T only suffers from forces applied by the recesses T1. Therefore, as the whole pressure area and the stress of the dough T are reduced, elastic dough T can be manufactured. This is the feature of Taiwan Patent No. 90200934.

However, as the upper side of the dough T is extruded, then the lower half of the dough T will diffuse outwards. Since each rotary wheel 11′ is arranged in the upper or lower sides, the portion of the dough T to be expanded will be resisted by the rotary wheels 11′ so that it is extruded in the gap between the upper and the lower rotary wheels 11. As a result, the dough T suffers from a preset force.

Therefore, in the present invention, the pressure to the dough T is effectively reduced so that elastic dough T is made. The main feature of the present invention is that the middle shafts 21 on the rotary wheels 11 are arranged eccentrically.

Embodiment 1

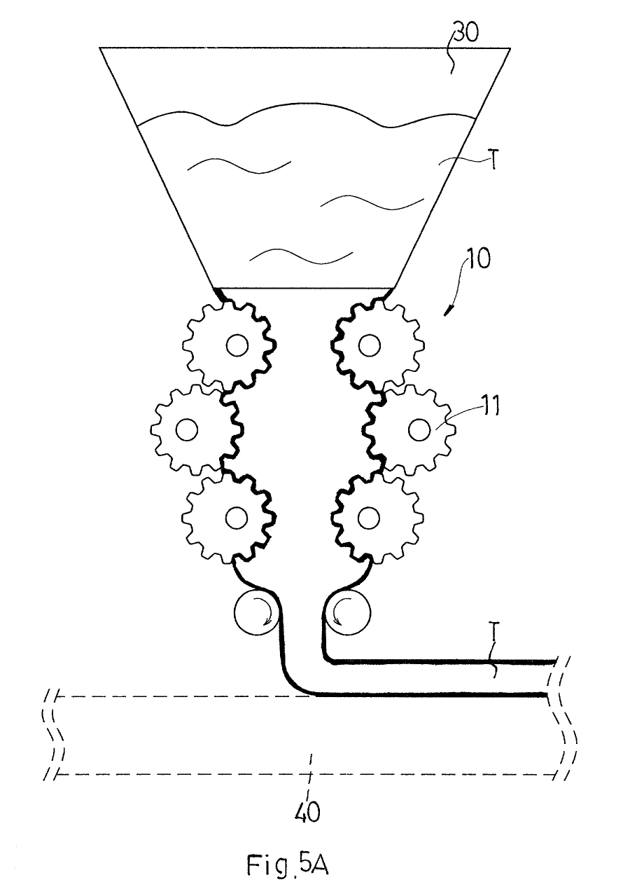

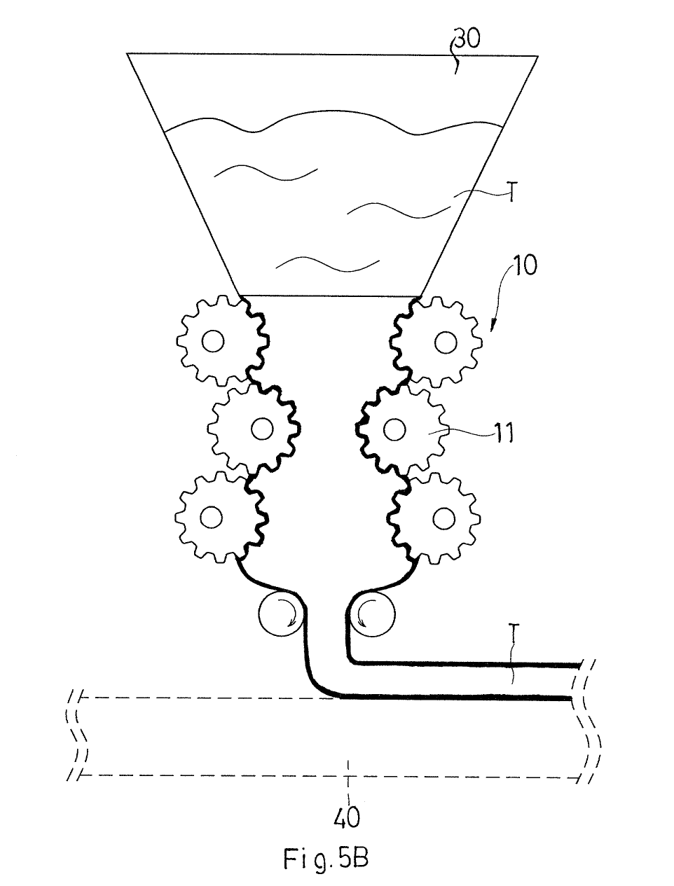

Referring to FIG. 5A, a plane schematic view showing the operation of the present invention is illustrated. The rotary wheels 11 at two sides of the extruding unit 10 are arranged inwards or outwards eccentrically and longitudinally. Therefore, as the motor 22 rotates, the rotary wheels 11 at two side of the extruding unit 10 rotate inwards or outwards sequentially with a downward sequence. In other words, the upper half of the dough T extrudes inwards due to the action of the rotary wheels 11 at the upper side so that the dough T at the lower half expands outwards. The rotary wheels 11 at the lower side will shift outwards, as a result, a space is formed for expanding the dough T, Thereby, by the rotary wheels 11 at two sides of the extruding unit 10 rotating inwards and outwards sequentially with a downward sequence, the dough T presents alternative actions of contraction and expansion with the outwards and inward rotation of the rotary wheels 11. Therefore, the force applying area of the dough T and the stress applied to the dough T by the rotary wheels 11 are reduced. As a consequent, elastic dough T can be made.

Embodiment 2

Referring to FIG. 5B, a plane schematic view showing the operation of the present invention is illustrated. The rotary wheels 11 at two sides of the extruding unit 10 are arranged outwards or inwards eccentrically and longitudinally. Therefore, the rotary wheels 11 at two side of the extruding unit 10 rotate outwards or inwards sequentially with a downward sequence. The dough T presents alternative actions of contraction and expansion with the outwards and inward rotation of the rotary wheels 11. As a consequent, the force applying area of the dough T and the stress applied to the dough T by the rotary wheels 11 are reduced. As a consequent, elastic dough T can be made.

Embodiment 3

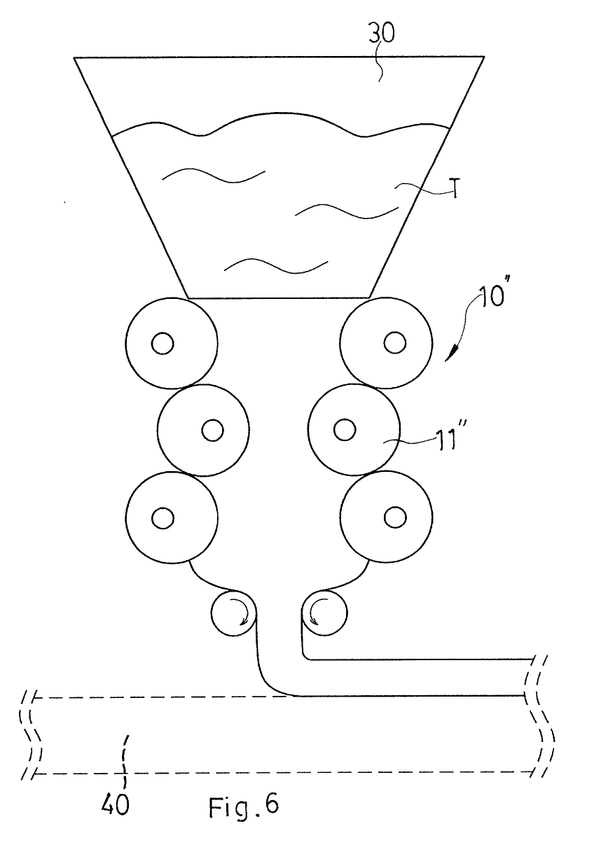

Referring to FIG. 6, another embodiment of the present invention is illustrated. The lateral surfaces of the rotary wheels 11′ at two sides of the extruding unit 10′ can be designed as planes. Thus, elastic dough T can be made.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A food extrusion device comprising:
an extruding unit formed by a plurality of rotary wheels arranged at two sides longitudinally, and an extruding space being formed between the rotary wheels of two sides;
a rotary unit formed by a plurality of middle shafts passing through each rotary wheel;
a material inlet disposed on the extruding space of the extruding unit; and
a transfer belt positioned at a bottom of the extruding space of the extruding unit;
wherein the rotary wheels at two sides of the extruding unit are arranged inwards or outwards eccentrically and longitudinally; as the rotary wheels at two side of the extruding unit rotate inwards or outwards sequentially with a downward sequence so that the dough slides downwards, the dough presents alternative actions of expansion and contraction with the outwards and inward rotation of the rotary wheels; therefore, the force applying area of the dough and the stress applied to the dough by the rotary wheels are reduced; as a consequent, elastic dough is made.

2. The food extrusion device as claimed in claim 1, wherein the rotary wheels at two sides of the extruding unit are arranged outwards or inwards eccentrically and longitudinally; therefore, the rotary wheels at two sides of the extruding unit rotate outwards or inwards sequentially with a downward sequence; the dough presents alternative actions of contraction and expansion with the outwards and inward rotation of the rotary wheels; as a consequent, the force applying area of the dough and the stress applied to the dough by the rotary wheels are reduced; as a consequent, elastic dough is made.

3. The food extrusion device as claimed in claim 1, wherein lateral surfaces of the rotary wheels at two sides of the extruding unit are designed as planes; and thus, elastic dough is made.
